(19) United States
(12) Patent Application Publication
(10) Pub. No.: US 2020/0079236 A1
(43) Pub. Date: Mar. 12, 2020

(54) RECHARGING SYSTEM, RECHARGING CONTROLLER, BATTERY CHARGER, USER TERMINAL, RECHARGING METHOD, AND STORAGE MEDIUM

(71) Applicant: NEC Corporation, Minato-ku, Tokyo (JP)

(72) Inventors: Jun MORIZONO, Tokyo (JP); Tsuyoshi ABE, Tokyo (JP); Yasuaki KONDO, Tokyo (JP); Jiroh KUBOTA, Tokyo (JP)

(73) Assignee: NEC Corporation, Minato-ku, Tokyo (JP)

(21) Appl. No.: 16/466,751

(22) PCT Filed: Dec. 7, 2017
(86) PCT No.: PCT/JP2017/043972

§ 371 Date: Jun. 5, 2019

(30) Foreign Application Priority Data
Dec. 15, 2016 (JP) 2016-243086

(51) Int. Cl. B60L 53/30; H02J 7/00; B60L 53/14; B60L 50/50; B60L 53/60

(52) U.S. Cl. CPC B60L 53/305; H02J 7/0027; B60L 53/60; B60L 50/50; B60L 53/14

(57) ABSTRACT

A recharging system according to one example embodiment of the present invention includes: battery chargers each capable of charging a battery of a vehicle; and recharging controllers each configured to control the battery chargers and capable of communicating with a server. Each of the recharging controllers includes a communication unit capable of wirelessly communicating with a user terminal, and the server acquires position information on the user terminal from the communication unit and transmits, to the recharging controllers corresponding to the position information, an instruction from the user terminal to start recharging.

### TECHNICAL FIELD

The present invention relates to a recharging system for electric motor vehicles, a recharging controller, a battery charger, a user terminal, a recharging method, and a storage medium.

### BACKGROUND ART

Due to increase of environmental interest, hybrid electric vehicles (HEV) and plug-in hybrid electric vehicles (PHV or PHEV) in which both an electric motor and an engine are used have become popular. Furthermore, in recent years, electric vehicles (EV) driven by an electric motor only have been developed.

To facilitate widespread use of electric motor vehicles, enhancement of a recharging system that charges a buttery is indispensable, various recharging systems have been proposed. For example, a recharging system disclosed in Patent Literature 1 includes a plurality of buttery chargers that can be connected to a vehicle, a recharging controller that manages a plurality of battery chargers, and a server connected to a network. The battery charger is typically provided in a parking lot of a shopping mall or the like, and the recharging controller may be installed at the entrance of the shop. In such a recharging system, a user is required to connect the battery charger to the vehicle by a connector cable and then operate the recharging controller to start recharging. That is, the user causes the recharging controller to read an ID card and enters the number of the battery charger connected to the vehicle, and thereby the recharging controller starts charging with the designated battery charger.

### CITATION LIST

### Patent Literature

PTL 1: Japanese Patent Application Laid-Open No. 2012-147555

### SUMMARY OF INVENTION

In the recharging system disclosed in Patent Literature 1, the user has to perform a complex operation to cause the recharging controller to read the ID card, enter a battery charger number, and the like. Further, when the recharging controller is installed distant from the battery charger, the user has to get off the vehicle and then move on foot to the recharging controller. In particular, when the recharging system is provided in a large parking lot, the distance from the battery charger to the recharging controller tends to be long, and the burden on the user becomes larger.

The present invention has been made in view of the above problem and intends to provide a recharging system that reduces burden at a user and is superior in user-friendliness.

### Solution to Problem

According to one example aspect of the present invention, provided is a recharging system including: battery chargers each capable of charging a battery of a vehicle; and recharging controllers each configured to control the battery chargers and capable of communicating with a server, each of the recharging controllers includes a communication unit capable of wirelessly communicating with a user terminal, and the server acquires position information on the user terminal from the communication unit and transmits, to the recharging controllers corresponding to the position information, an instruction from the user terminal to start recharging.

According to another example aspect of the present invention, provided is a recharging controller that controls battery chargers each capable of charging a battery of a vehicle and is capable of communicating with a server, the recharging controller including a communication unit capable of wirelessly communicating with a user terminal, and the server acquires position information on the user terminal and transmits, to the recharging controller corresponding to the position information, an instruction from the user terminal to start recharging.

According to another example aspect of the present invention, provided is a battery charger that is controlled by a recharging controller capable of communicating with a server and is capable of charging a battery of a vehicle, the recharging controller includes a communication unit capable of wirelessly communicating with a user terminal, and the server acquires position information on the user terminal from the recharging controller and transmits, to the recharging controller corresponding to the position information, an instruction from the user terminal to start recharging.

According to another example aspect of the present invention, provided is a user terminal capable of wirelessly communicating with a recharging controller that controls battery chargers each capable of charging a battery of a vehicle and is controlled by a server, the recharging controller includes a communication unit capable of wirelessly communicating with a user terminal, and the server acquires position information on the user terminal from the communication unit and transmits, to the recharging controller corresponding to the position information, an instruction from the user terminal to start recharging.

According to another example aspect of the present invention, provided is a recharging method performed by a recharging system including battery chargers each capable of charging a battery of a vehicle and recharging controllers each configured to control the battery chargers and capable of communicating with a server, and the recharging method includes steps of: acquiring position information on a user terminal from the recharging controllers; and transmitting, from the server to the recharging controllers corresponding to the position information, an instruction from the user terminal to start recharging.

According to another example aspect of the present invention, provided is a storage medium storing a program that causes a computer to execute a recharging method performed by a recharging system comprising battery chargers each capable of charging a battery of a vehicle and recharging controllers each configured to control the battery chargers and capable of communicating with a server, and the recharging method includes steps of: acquiring position information on a user terminal from the recharging controllers; and transmitting, from the server to the recharging controllers corresponding to the position information, an instruction from the user terminal to start recharging.

According to another example aspect of the present invention, provided is a storage medium storing a program that causes a computer to execute a recharging method performed by a recharging controller that controls battery chargers each capable of charging a battery of a vehicle and is capable of communicating with a server, and the recharging method includes steps of: at a wireless communication unit, wirelessly communicating with a user terminal, and at the recharging controller corresponding to position information on the user terminal acquired by the server, receiving, from the server, an instruction from the user terminal to start recharging.

According to another example aspect of the present invention, provided is a storage medium storing a program that causes a computer to execute a recharging method performed by a battery charger that is controlled by a recharging controller capable of communicating with a server and is capable of charging a battery of a vehicle, and the recharging method includes a step of: by the recharging controller wirelessly communicating with a user terminal by using a communication unit, and by the server transmitting, to the recharging controllers corresponding to the position information on the user terminal, an instruction from the user terminal to start recharging, the battery charger receiving the instruction to start recharging from the recharging controller.

According to another example aspect of the present invention, provided is a storage medium storing a program that causes a computer to execute a recharging method performed by a user terminal capable of wirelessly communicating with a recharging controller that controls battery chargers each capable of charging a battery of a vehicle and is controlled by a server, and the recharging method includes a step of: the user terminal wirelessly communicating with a communication unit of the recharging controller, the server acquires position information on the user terminal from the communication unit and transmits, to the recharging controller corresponding to the position information, an instruction from the user terminal to start recharging.

According to the present invention, a recharging system that reduces burden at a user and is superior in user-friendliness can be provided.

### BRIEF DESCRIPTION OF DRAWINGS

FIG. 1 is a block diagram of a recharging system of an electric motor vehicle in a first example embodiment.

FIG. 2 is a block diagram of a recharging controller in the first example embodiment.

FIG. 3 is a block diagram of a battery charger in the first example embodiment.

FIG. 4 is a block diagram of a charging circuit of a vehicle in the first example embodiment.

FIG. 5 is a block diagram of a user terminal in the first example embodiment.

FIG. 6 is a sequence chart illustrating user registration process in the first example embodiment.

FIG. 7 is a sequence chart of the recharging system in the first example embodiment.

FIG. 8 is a sequence chart of the recharging system in the first example embodiment.

FIG. 9 is a sequence chart of the recharging system in the first example embodiment.

FIG. 10A is a display screen of the user terminal in the first example embodiment.

FIG. 10B is a display screen of the user terminal in the first example embodiment.

FIG. 10C is a display screen of the user terminal in the first example embodiment.

FIG. 10D is a display screen of the user terminal in the first example embodiment.

FIG. 11A is a display screen of the user terminal in the first example embodiment.

FIG. 11B is a display screen of the user terminal in the first example embodiment.

FIG. 11C is a display screen of the user terminal in the first example embodiment.

FIG. 11D is a display screen of the user terminal in the first example embodiment.

FIG. 12 is a sequence chart of a recharging system in a second example embodiment.

FIG. 13 is a sequence chart of the recharging system in the second example embodiment.

FIG. 14 is a sequence chart of a recharging system in the second example embodiment.

FIG. 15 is a general configuration diagram of a recharging system in a fourth example embodiment.

### DESCRIPTION OF EMBODIMENTS

Example embodiments of the present invention will be described below with reference to the drawings.

### First Example Embodiment

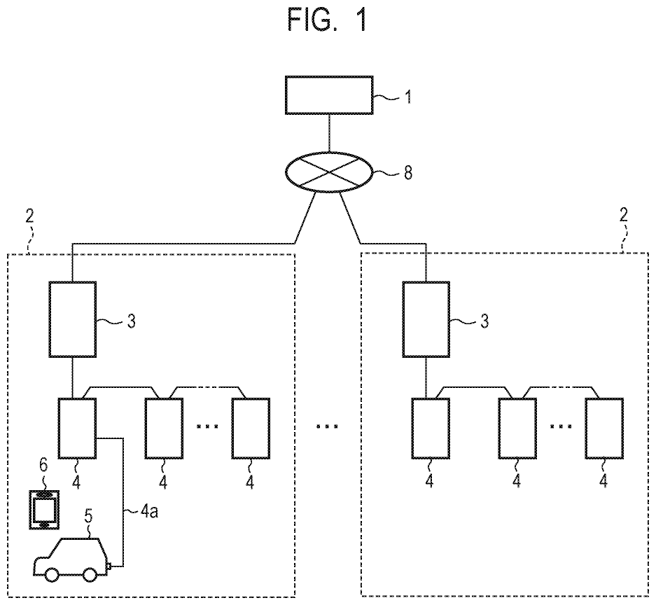

FIG. 1 is a block diagram of a recharging system of an electric motor vehicle in the present example embodiment. The recharging system includes recharging controllers 3 connected to a server 1 and battery chargers 4 each capable of charging a vehicle. The server 1 is a so-called cloud server and is connected to a user terminal 6 and the recharging controllers 3 via a network 8. The server 1 includes a CPU, a memory device, and a storage device and may perform not only storage and management of registration information, payment information, recharging history, or the like of users but also management of the recharging controllers 3 and the battery chargers 4.

The recharging controllers 3 and the battery chargers 4 are provided in a parking lot of a shopping mall, a charging station in a town, or the like. Each of the recharging controllers 3 is installed near entrance of a facility having a parking lot 2, for example, and each of the battery chargers 4 is provided near a parking space for each vehicle. The plurality of battery chargers 4 are connected to the recharging controller 3 in a cascade manner by serial communication. While the number of battery chargers 4 may be over several thousands, this does not exclude the number being one. Each of the battery chargers 4 has a charging cable 4a, and when the charging cable 4a is connected to a vehicle 5, a current is supplied from the battery charger 4 to a battery of the vehicle 5. While the battery charger 4 is typically a normal battery charger, the battery charger 4 may be a quick battery charger. The vehicle 5 is an electric motor vehicle such as a hybrid electric vehicle (HEV) or a plug-in hybrid electric vehicle (PHEV) in which both an electric motor and an engine are used or an electric vehicle (EV) driven by an electric motor only. In the description below, these electric motor vehicles will be simply referred to as a “vehicle”. The user terminal 6 may be a mobile terminal such as a smartphone or a tablet computer or an information device such as a portable computer.

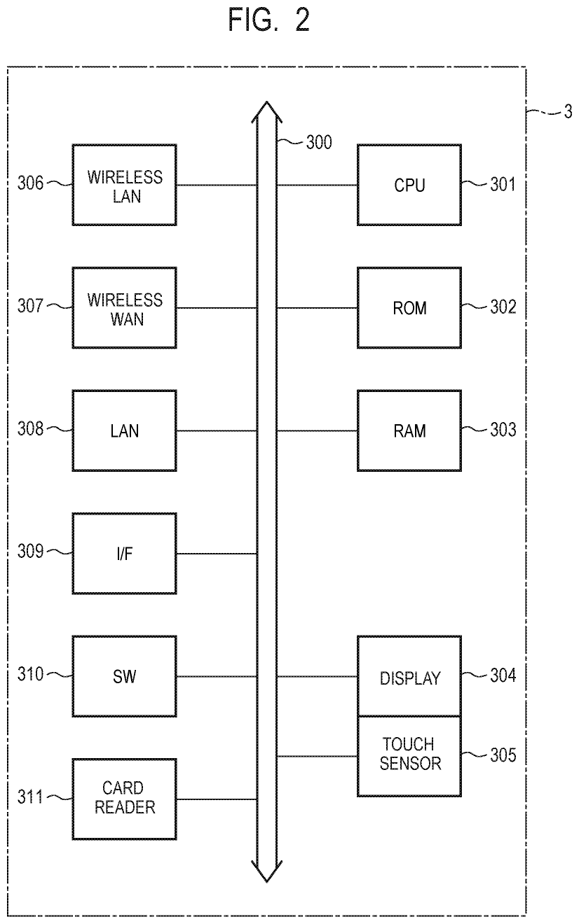

FIG. 2 is a block diagram of a recharging controller 3 in the present example embodiment. The recharging controller 3 includes a bus 300, a CPU 301, a read-only memory (ROM) 302, a random access memory (RAM) 303, a display 304, a touch sensor 305, a wireless local area network (LAN) unit 306, a wireless wide area network (WAN) unit 307, a LAN unit 308, an interface (I/F) 309, a switch (SW) 310, and a card reader 311.

The CPU 301 executes a recharge process in accordance with a predefined application program. The application program may be written in the ROM 302 or may be downloaded from the server 1 via the network 8. The RAM 303 provides a memory region necessary for the operation of the CPU 301. The display 304 is a touchscreen on which the touch sensor 305 is arranged on the surface thereof. A number provided to the battery charger 4, a recharge level, a billing amount, or the like may be displayed on the display 304. The wireless LAN unit 306 (communication unit) is a wireless transceiver unit based on the Wi-Fi standard, for example. It is desirable that the transmittable area of the wireless LAN unit 306 cover the entire parking lot, that is, the region where the recharging controller 3 and the battery chargers 4 are provided. The wireless WAN unit 307 is a transceiver unit capable of connecting to a public wireless line such as 3G, LTE, 4G, or the like and wirelessly communicates with a base station (not illustrated). The wireless LAN unit 306 and the wireless WAN unit 307 are used for communication with a vehicle. Note that, when the parking lot is relatively narrow, near-field communication such as Bluetooth (registered trademark) may be used.

The I/F 309 is an interface unit based on a serial communication standard such as RS232C, RS485, or the like and is able to communicate with the plurality of battery chargers 4 connected in a cascade manner. The card reader 311 is a device that reads information such as a member's card, an electronic money card, or the like, which may be a contact-type or a contactless type.

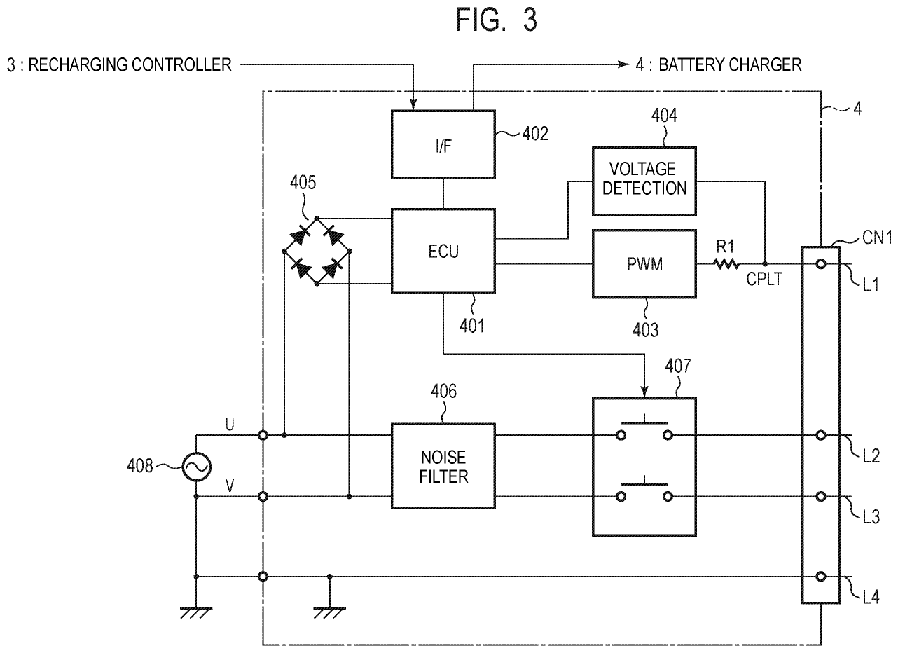

FIG. 3 is a block diagram of the battery charger 4 in the present example embodiment. The battery charger 4 includes an ECU 401, an I/F 402, a pulse width modulation (PWM) circuit 403, a voltage detection circuit 404, a rectifier circuit 405, a noise filter 406, a relay switch 407, and a connector CN1. The ECU 401 is formed of a CPU, a memory device, and the like and executes a recharge process in accordance with a predefined application program. The application program may be written in a memory in advance or may be downloaded from a network. The I/F 402 is a serial communication interface unit according to RS223C, RS485, or the like and may be connected to the recharging controller 3 and other battery chargers 4.

The PWM circuit 403 includes an oscillation circuit, a pulse width modulation circuit, and a voltage control circuit and outputs a pilot signal Control Pilot (CPLT) based on the standard of SAE Electric Vehicle Conductive Charge Couple, SAE J1722, IEC6185. As described later, the pilot signal CPLT is a control signal that represents start and end of recharging, an instruction of a current amount, a connection state of a charging cable, or the like by changing the voltage and the pulse width thereof. The output terminal of the PWM circuit 403 is connected to the connector CN1 via the resistor R1. The voltage detection circuit 404 is formed of a voltage comparator circuit or the like and detects the voltage of the pilot signal CPLT.

The rectifier circuit 405 includes a diode-bridge circuit, converts an alternating current supplied from an AC power source 408 into a direct current, and supplies a power source voltage to the ECU 401, the I/F 402, the PWM circuit 403, and the voltage detection circuit 404. Although not illustrated, the rectifier circuit 405 may include a smoothing circuit such as an inductor, a capacitor, or the like. A noise filter 406 is a filter circuit that removes a surge noise or the like included in the AC power source 408. The relay switch 407 has an electromagnetic solenoid and a moving contact and causes an electric path between the AC power source 408 and the connector CN1 to be opened or closed in accordance with a control signal from the ECU 401. The connector CN1 is connected to the charging cable 4a, and the charging cable 4a includes a control signal line L1, power source lines L2 and L3, and a ground line L4.

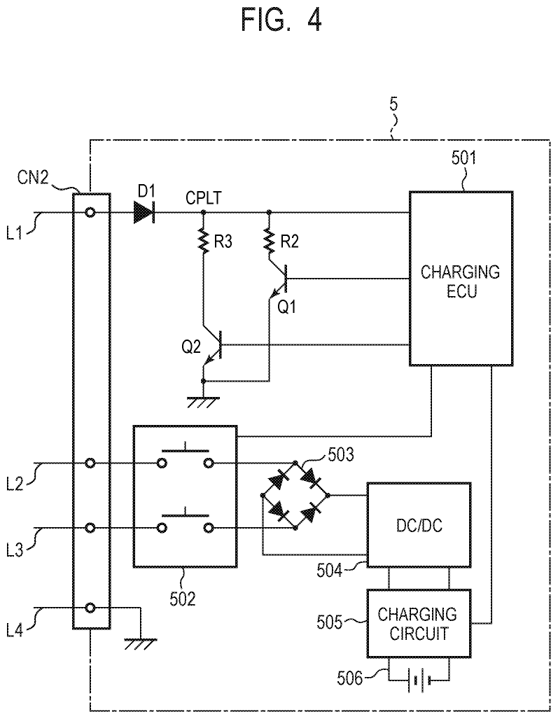

FIG. 4 is a block diagram of a charging circuit of the vehicle 5 in the present example embodiment. The charging circuit of the vehicle 5 includes a charging ECU 501, a relay switch 502, a rectifier circuit 503, a DC/DC converter 504, a charging circuit 505, a battery 506, and a connector CN2. The plug of the charging cable 4a is connected to the connector CN2, which forms electrical paths to the control signal line L1, the power source lines L2 and L3, the ground line L4, and the vehicle 5. The charging ECU 501 includes a CPU, a memory, an analog-to-digital converter, and the like and executes a process according to a predefined application program. A CPLT signal is input to the input terminal of the charging ECU 501 from the connector CN2 and a diode D1 via the control signal line L1. Each one end of resistors R2 and R3 is connected to the control signal line L1. The other end of the resistor R2 is connected to the collector of a transistor switch Q1, and the emitter thereof is grounded. Further, the other end of the resistor R3 is connected to the collector of a transistor switch Q2, and the emitter thereof is grounded. The control signal is input to the gates of the transistor switches Q1 and Q2 from the charging ECU, a high level voltage is applied to the gates, and thereby the transistor switches Q1 and Q2 are turned on.

When the transistor switches Q1 and Q2 are turned off, a voltage resulted by subtracting the forward voltage of the diode D1 (around 0.7 V) from the voltage of the CPLT signal occurs on the control signal line L1. Further, when the transistor switch Q1 is turned on, a voltage resulted by multiplying the voltage of the pilot signal CPLT by the ratio R2/(R1+R2) occurs on the control signal line L1. Furthermore, when both the transistor switches Q1 and Q2 are turned on, a voltage resulted by multiplying the voltage of the pilot signal CPLT by the ratio (R2×R3/(R2+R3))/(R1+(R2×R3/(R2+R3))) occurs. As discussed above, by the charging ECU 501 turning on and off the transistor switches Q1 and Q2, it is possible to change the voltage of the CPLT signal. The voltage change of the pilot signal CPLT may be detected in the charging ECU 501 and the voltage detection circuit 404 of the battery charger 4, respectively.

The relay switch 502 is controlled by the charging ECU 501 to open and close the electrical path between the connector CN2 and the rectifier circuit 503. The rectifier circuit 503 converts an alternating current into a direct current and supplies a DC current to the DC/DC converter 504. The DC/DC converter 504 steps up the rectified DC voltage to a voltage necessary for charging the battery 506. The charging circuit 505 has a circuit that controls a current supplied to the battery 506, a protection circuit, and the like. By supplying a current from the charging circuit 505 to the battery 506, the battery 506 is charged.

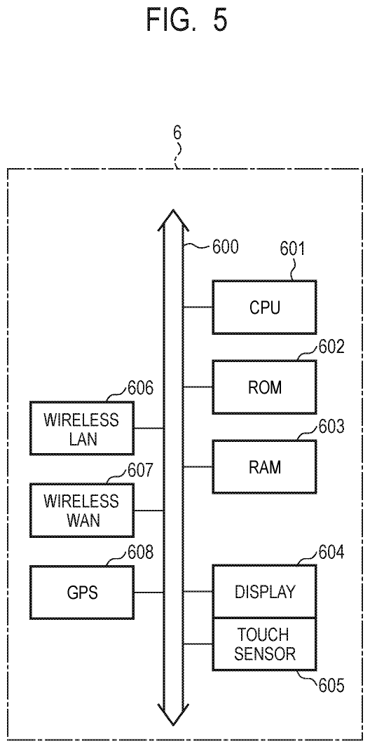

FIG. 5 is a block diagram of the user terminal 6 in the present example embodiment. As described above, the user terminal 6 may be formed of an information device such as a smartphone, a tablet computer, a car navigation system, or the like. The user terminal 6 is not necessarily limited to a mobile terminal separated from the vehicle 5 and may be an on-vehicle device having some of the plurality of ECUs of the vehicle 5, however, a mobile terminal will now be described as an example. The user terminal 6 has a bus 600, a CPU 601, a ROM 602, a RAM 603, a display 604, a touch sensor 605, a wireless LAN unit 606, a wireless WAN unit 607, and a Global Positioning System (GPS) unit 608. The bus 600 includes an address bus and a data bus and inputs and outputs data to and from the circuit such as the CPU 601. The CPU 601 executes an operating program and an application program and performs control of the entire user terminal 6. The ROM 602 is formed of a nonvolatile memory and stores an operating program, an application program, or the like. The RAM 603 provides a memory region necessary for the operation of the CPU 601. The display 604 is a touchscreen on which the touch sensor 605 is arranged on the surface thereof. An identification number of the recharging controller 3, an identification number of the battery charger 4, a recharge level, a billing amount, or the like may be displayed on the display 604.

The wireless LAN unit 606 is a wireless transceiver unit based on the Wi-Fi standard, for example. The wireless WAN unit 607 is a transceiver unit capable of connecting to a wireless line of mobile phones, such as 3G, LTE, 4G, or the like. Note that the wireless LAN unit 606 and the wireless WAN unit 607 may be used for communication with the vehicle 5. The GPS unit 608 is able to measure the position of the user terminal 6 by receiving an electric wave from a plurality of GPS satellites. It is possible to detect whether or not the vehicle 5 enters a recharge service area based on the position measured by the GPS unit 608.

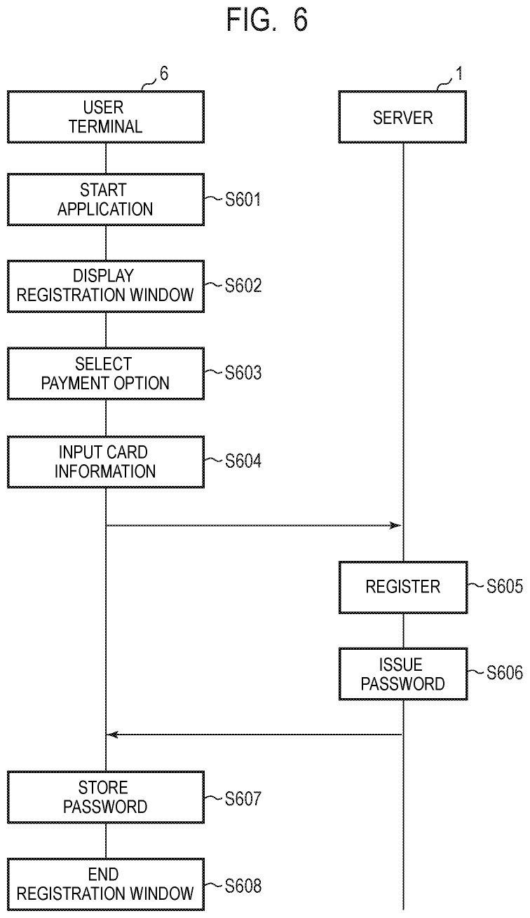

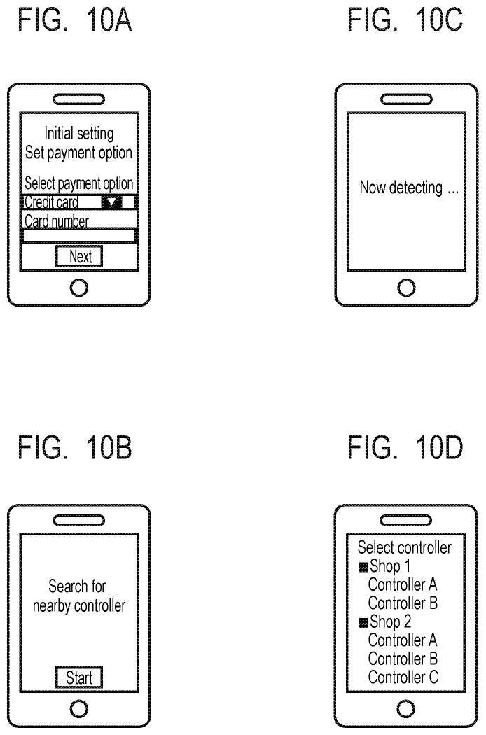

FIG. 6 is a sequence chart illustrating a user registration process in the present example embodiment. First, the user touches an icon displayed on the display 604 to start an application program (step S601). Once the user further selects an item of an initial setting from a menu window of the application program, the user terminal 6 displays a registration window on the display 604 (step S602). FIG. 10A illustrates an example of a registration window. Once the user touches an arrow displayed below “Select payment option”, multiple payment options are displayed. The user may select a desired payment option from the displayed multiple payment options (step S603). Once the user selects a credit card payment, an entry field of “Card number” is displayed below a registration window. The user causes a software keyboard to be displayed on the screen and inputs a card number (step S604). Although not illustrated in FIG. 10A, personal information such as a user name, a contact address, or the like may be input. The registration information such as the payment option, the card number, or the like input by the user is transmitted to the server 1 via a communication line. The server 1 checks whether there is no error in the transmitted registration information and registers the registration information to the database (step S605). The server issues an authentication password and transmits the authentication password to the user terminal 6 (step S606). An effective period may be defined for the authentication password. The user terminal 6 stores the transmitted authentication password and the expiration date in the application program (step S607). Upon the completion of the above registration process, the user terminal 6 ends the display of the registration window (step S608).

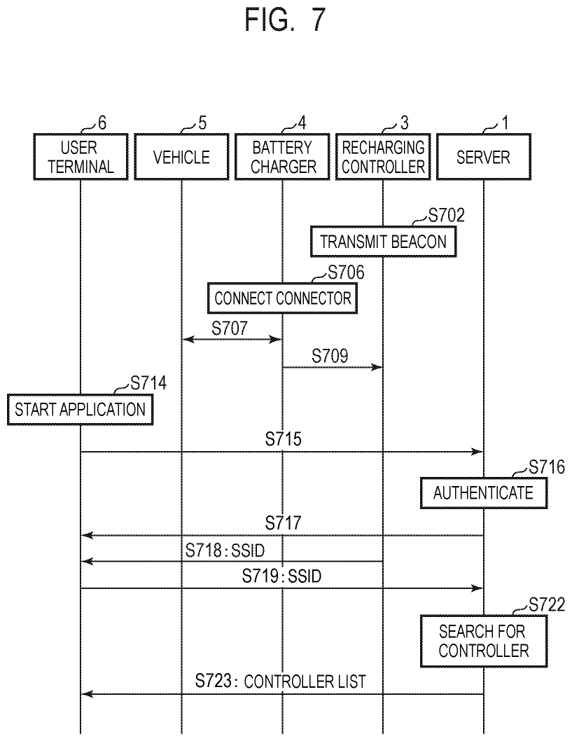

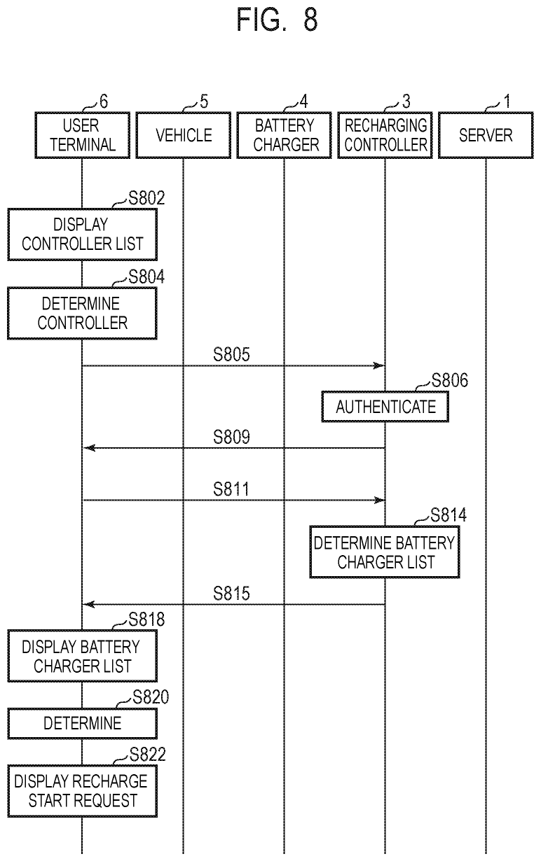

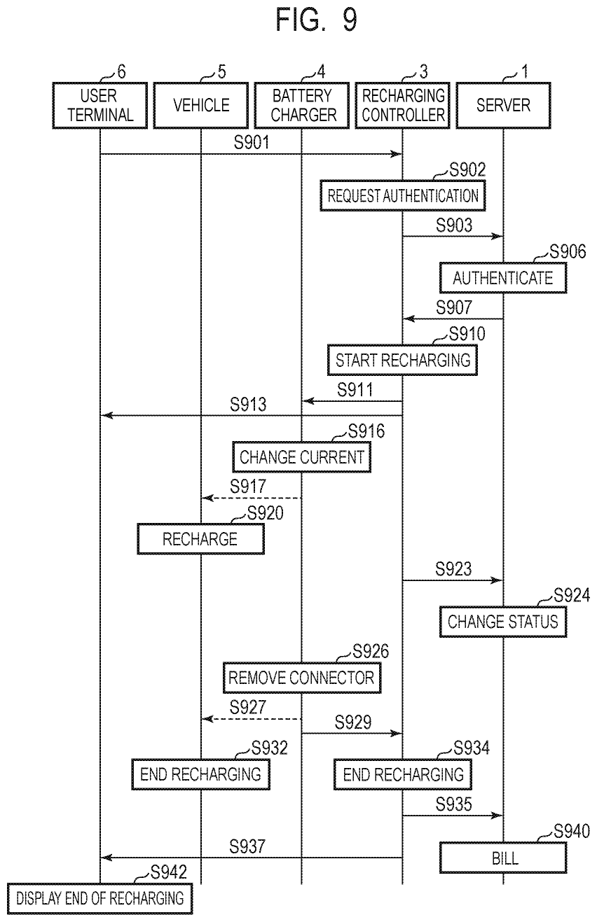

FIG. 7, FIG. 8, and FIG. 9 are sequence charts of the recharging system in the present example embodiment. The recharging controller 3 continues to transmit a beacon at a constant cycle (for example, 100 msec) from the wireless LAN unit 306 (step S702). The beacon includes a Service Set ID (SSID) that is the identifier of the wireless LAN unit 306, channel (frequency) information, security information, or the like. The vehicle 5 enters a parking lot 2, and the user stops the vehicle 5 in front of the battery charger 4 and connects the charging cable 4a to the connector CN2 of the vehicle 5 (step S706). In the battery charger 4, due to the connection of the charging cable 4a to the vehicle 5, the voltage of the pilot signal CPLT decreases from 12 V to 9 V (step S707). In response to detecting that the voltage of the pilot signal CPLT becomes 9 V, the battery charger 4 determines that the charging cable 4a is connected to the vehicle 5 and turns on and off an LED. Furthermore, the battery charger 4 notifies the recharging controller 3 of the completion of connection of the vehicle 5 to the battery charger 4 together with the identification number of the battery charger 4 (step S709).

Once the user starts the application program at the user terminal 6 (step S714), the user terminal 6 transmits information such as a card number, a password, or the like to the server 1 via the wireless WAN unit 607 (step S715). The server 1 performs authentication of the card number and the password (step S716) and transmits an authentication result to the user terminal 6 (step S717). At this time, when the password has expired, the user may newly acquire a password from the registration window (FIG. 10A). When the authentication is successful, the user terminal 6 starts detecting the recharging controller 3 nearby. For example, in the display screen of FIG. 10B, once the user touches the button of “Start”, the user terminal 6 starts detecting the recharging controller 3 and displays a message of “Now detecting . . . ” on the display 604 (FIG. 10C). When the user terminal 6 has entered a parking lot, that is, the transmittable area of the recharging controller 3, the user terminal 6 receives an SSID (step S718). When a plurality of parking lots are located adjacently, the user terminal 6 may receive a plurality of SSIDs. In this case, the user terminal 6 acquires a plurality of SSIDs. The user terminal 6 transmits a list of the acquired SSIDs to the server 1 via the wireless WAN 607 (step S719).

The server 1 compares the list of the received SSIDs with the database stored in the server 1 and searches for the battery controllers 3 corresponding to the respective SSIDs and shops where these battery controllers 3 are installed (step S722). The server 1 transmits information on the searched recharging controllers 3 and shops to the user terminal 6 (step S723). Note that the server 1 may acquire an IP address of the wireless LAN unit 306 as position information. Further, a conversion table of the SSIDs and the recharging controllers 3 may be pre-stored in the user terminal 6, and the user terminal 6 may search for the recharging controller 3 corresponding to an SSID. In such a case, the user terminal 6 does not require to inquire the server 1 for information on the recharging controller 3.

In FIG. 8, the user terminal 6 displays information on a shop or the like transmitted from the server 1 on the display 604 (step S802). For example, the recharging controllers 3 are classified on a shop basis and displayed (see FIG. 10D) such as “Shop 1: Controller A, Controller B” and “Shop 2: Controller A, Controller B, Controller C”. The displayed recharging controllers 3 correspond to the SSIDs received by the user terminal 6 and include not only the recharging controller 3 which is used to charge the vehicle 5 of the user but also one or more adjacent recharging controllers 3. The user determines the recharging controller 3 which is used to charge the vehicle of the user out of the plurality of displayed recharging controllers 3 (step S804). For example, the user may determine the recharging controller 3 by touching “Controller A” of the shop 1 on the display 604.

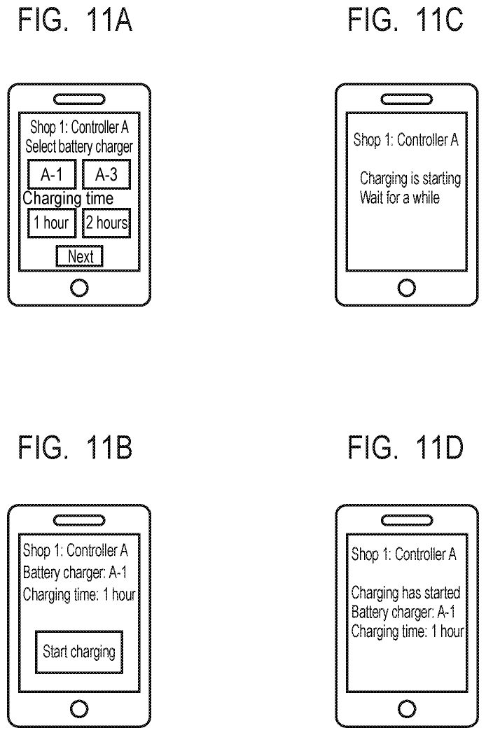

The user terminal 6 performs authentication request on the determined recharging controller 3 (step S805). While an authentication scheme is not limited, Remote Authentication Dial In User Service (Radius), Lightweight Directory Access Protocol (LDAP), or the like can be used. Further, various authentication schemes such as public key authentication, digital certification, or the like may be used. The recharging controller 3 performs authentication (step S806) and transmits a result of the authentication to the user terminal 6 (step S809). When the authentication is successful, the user terminal 6 requires a list of available battery chargers 4 from the recharging controller 3 (step S811). The recharging controller 3 detects the battery charger 4 whose charging cable 4a is connected to the vehicle 5 and in which recharging has not yet been started out of the plurality of battery chargers 4 connected to the recharging controller 3 of interest (step S814). Note that a plurality of battery chargers 4 may be detected when a plurality of users try to start recharging at the same time. The server 1 transmits the list of the detected battery chargers 4 to the user terminal 6 (step S815), and the user terminal 6 displays the list of the battery chargers 4 on the display 604 (step S818). As illustrated in FIG. 11A, the display screen includes identification numbers “A-1” and “A-3” of the battery chargers 4 which are enabled to start recharging in “Shop 1: Controller A”. Further, the display screen includes display of selectable recharging time periods. For example, when the vehicle 5 of the user is connected to the battery charger 4 of the identification number “A-1”, the user will select the battery charger 4 of the identification number “A-1” on the display 604. Furthermore, the user selects a recharging time period and touches a button “Next” to determine the battery charger 4 and a recharging time period (step S820).

Next, the user terminal 6 displays a request for start of recharging on the display 604 and urges the user to start recharging (step S822). For example, as illustrated in FIG. 11B, a recharge condition such as “Shop 1: Controller A”, “Battery charger: A-1”, and “Charging time: 1 hour” is displayed. In FIG. 9, when the user checks the recharge condition and touches the display of “Start charging”, the user terminal 6 displays that recharging is ongoing on the display 604 (FIG. 11C) and transmits an authentication request to the recharging controller 3 (step S901). The authentication request may include a recharge start request, the identification number of the battery charger 4, a recharging time period, payment information (a user ID, a password), or the like. The recharging controller 3 receives authentication request from the user terminal 6 (step S902) and further performs request for authentication of the user on the server 1 (step S903). The server 1 references a database for the authentication request (step S906) and transmits an authentication result to the recharging controller 3 (step S907).

When the authentication is successful, the recharging controller 3 determines start of recharging (step S910) and instructs the battery charger 4 with the identification number “A-1” to start recharging (step S911). Furthermore, the recharging controller 3 notifies the user terminal 6 of the start of recharging (step S913), and the user terminal 6 displays on the display 604 that recharging is started (FIG. 11D). The battery charger 4 changes the maximum current from 0 A to 15 A, for example (step S916). The maximum current is determined by the duty ratio of the pilot signal CPLT as described above. The charging ECU 501 detects the duty ratio of the pilot signal CPLT (step S917) and starts recharging at the determined maximum current (step S920). That is, the charging ECU 501 turns on the relay switch 502 and charges the battery 506 with a current supplied from the battery charger 4.

The battery charger 4 notifies the recharging controller 3 that the maximum current has been changed to 15 A, and the recharging controller 3 notifies the server 1 that the recharging at the maximum current of 15 A has been started at the battery charger 4 (step S923). The server 1 records as a status that recharging at the user ID was started (step S924).

Upon the completion of recharging at the vehicle 5, the user removes the charging cable 4a from the vehicle 5 (step S926). In the vehicle 5, the pilot signal CPLT becomes a low level, and thus the charging ECU 501 can detect the removal of the charging cable 4a (steps S927 and S932). In the battery charger 4, the pilot signal CPLT becomes 12 V, and thus the battery charger 4 can detect the removal of the charging cable 4a. The battery charger 4 notifies the recharging controller 3 that the charging cable 4a has been removed and the recharging has ended (step S929). In response to receiving the end of recharging at the battery charger 4 (step S934), the recharging controller 3 transmits, to the server 1, a notification of the end of recharging together with the identification number “A-1” of the battery charger 4 (step S935). The server 1 changes the status from “charging” to “charged”. The recharging controller 3 transmits the user ID, the identification number of the battery charger 4, the recharging time period, the recharge start/end time, the electric energy, or the like to the server 1 as billing information, and the server 1 performs a billing process at the user account (step S940). Furthermore, the recharging controller 3 transmits a notification of the end of recharging to the user terminal 6 (step S937), and the user terminal 6 displays on the display 604 that the recharging has ended (step S942).

As discussed above, according to the present example embodiment, the user is able to start recharging without leaving his/her vehicle and operating a recharging controller, which can enhance user-friendliness.

Note that, while the recharging controller 3 transmits identification signals sequentially to the respective battery chargers 4 connected to the vehicle 5 as detection targets in the present example embodiment, all the battery charges 4 may be detection targets regardless of whether or not the vehicle 5 is connected thereto. Further, the battery charger 4 which has completed recharging of the vehicle 5 may be excluded from the detection targets.

### Second Example Embodiment

Next, a recharging system in the second example embodiment will be described. In the present example embodiment, the user terminal 6 can measure a position of the user terminal 6 by receiving electric waves from a plurality of GPS satellites by using the GPS unit 608. It is possible to detect whether or not the vehicle 5 has entered an area of a battery charging service based on a position measured by the GPS unit 608. The present example embodiment will be described below mainly for features different from the first example embodiment.

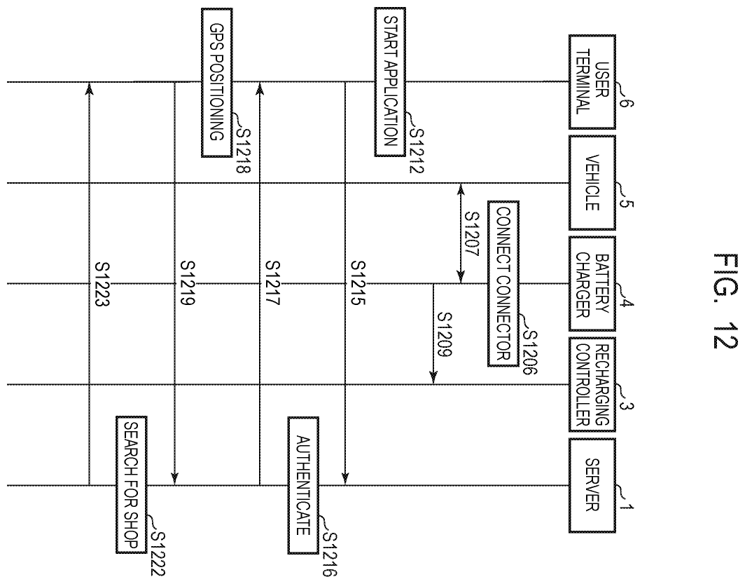

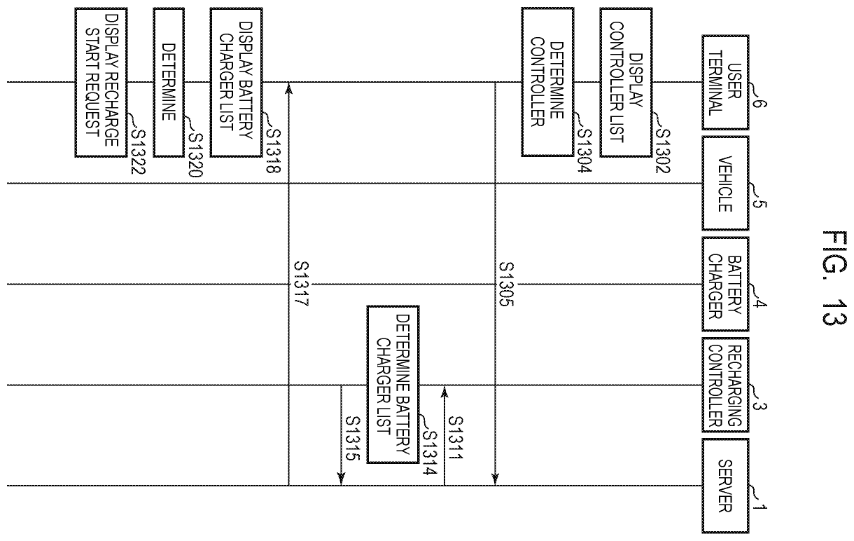

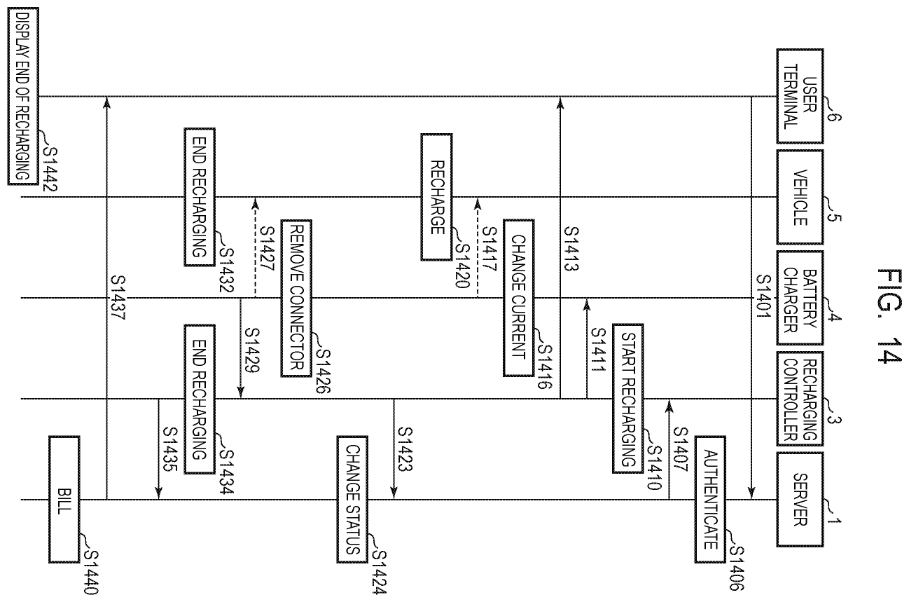

FIG. 12, FIG. 13, and FIG. 14 are sequence charts of the recharging system in the present example embodiment. In the description below, it is assumed that the user has completed user registration to the server 1 by using the user terminal 6. In FIG. 12, the vehicle 5 enters the parking lot 2, and the user stops the vehicle 5 in front of the battery charger 4 and connects the charging cable 4a to the vehicle 5 (step S1206). In the battery charger 4, due to the connection of the charging cable 4a to the vehicle 5, the voltage of the pilot signal CPLT decreases (step S1207). Furthermore, the battery charger 4 notifies the recharging controller 3 of the connection of the battery charger 4 to the vehicle 5 together with the identification number of the battery charger 4 (step S1209).

The user starts an application program at the user terminal (step S1212), and the user terminal 6 transmits information such as a card number, a password, or the like to the server 1 (step S1215). The server 1 performs authentication of the card number and the password (step S1216) and transmits an authentication result to the user terminal 6 (step S1217). Once the authentication is successful and the user provides instruction of detection of controllers nearby on the display screen of FIG. 10B, the user terminal 6 acquires position information by using the GPS unit 608 (step S1218). The user terminal 6 transmits the acquired position information to the server 1 (step S1219). The server 1 compares the received position information with the database stored in the server 1 and searches for the recharging controller 3 near the user terminal 6 and the shop where the recharging controller 3 of interest is installed (step S1222). The server 1 transmits information on the searched recharging controller 3 and the searched shop to the user terminal 6 (step S1223).

In FIG. 13, the user terminal 6 displays information on the shop or the like transmitted from the server 1 on the display 604 (step S1302). The user determines, out of the plurality of displayed recharging controllers 3, the recharging controller 3 which is used to recharge his/her vehicle 5 (step S1304). The user terminal 6 transmits information on the determined recharging controller 3 to the server 1 (step S1305), and the server 1 requests a list of available battery chargers 4 from the recharging controller 3 (step S1311). The recharging controller 3 detects the battery charger 4 whose charging cable 4a is connected to the vehicle 5 and in which recharging has not yet been started out of the plurality of battery chargers 4 connected to the recharging controller 3 of interest (step S1314). The server 1 transmits the list of the detected battery chargers 4 to the server 1 (step S1315) and further transmits the list of the battery chargers 4 to the user terminal 6 (step S1317). The user terminal 6 displays the list of the battery chargers 4 on the display 604 (step S1318), and the user determines the battery charger 4 and a recharging time period on the display 604 (step S1320).

Subsequently, the user terminal 6 displays a request for start of recharging on the display 604 to urge the user to start recharging (step S1322). In FIG. 14, once the user inputs an instruction of start of recharging to the user terminal 6, the user terminal 6 transmits an authentication request to the server 1 (step S1401). The authentication request may include a recharge start request, an identification number of the battery charger 4, a recharging time period, payment information (a user ID, a password), or the like. The server 1 references a database for the authentication request (step S1406) and transmits an authentication result to the recharging controller 3 (step S1407).

When the authentication is successful, the recharging controller 3 determines start of recharging (step S1410) and instructs the battery charger 4 determined at the user terminal 6 to start recharging (step S1411). Furthermore, the recharging controller 3 notifies the user terminal 6 of the start of recharging (step S1413), and the user terminal 6 displays that recharging has started on the display 604. The battery charger 4 changes the maximum current from 0 A to 15 A, for example (step S1416). The charging ECU 501 detects the duty ratio of the pilot signal CPLT (step S1417) and starts recharging at the determined maximum current (step S1420). Since the subsequent process (steps S1423 to S1442) is the same as the process in the first example embodiment (steps S923 to S942), the description thereof will be omitted.

Also in the present example embodiment, it is possible to detect the nearby recharging controller 3 using the position information obtained by the GPS, and thus the user is able to start recharging without directly operating the recharging controller 3. While position information obtained by the GPS is used in the recharging system in the present example embodiment, the position of the user terminal 6 may be detected at high accuracy by using the position information obtained from an SSID together. For example, when the battery charger 4 is installed in an underground facility and the GPS wave cannot be received, acquisition of position information by using the SSID of a wireless LAN is particularly effective. Furthermore, the user may acquire position information manually. For example, when the vehicle 5 enters a parking lot, the user may scan a code or the like attached to the recharging controller 3 by using the user terminal 6 and thereby identify the recharging controller 3.

### Third Example Embodiment

In the first and second example embodiments, the process in a state where the server 1 and the recharging controller 3 are able to communicate with each other has been described. In a recharging system of a third example embodiment, when the communication between the server 1 and the recharging controller is disconnected (offline), the recharging controller 3 may authenticate the user terminal 6 and start recharging. That is, while the server 1 performs authentication of the user terminal 6 in step S716 of FIG. 7 to FIG. 9, the recharging controller 3 instead of the server 1 performs authentication of the user terminal 6. When the authentication performed by the recharging controller 3 is successful, the recharging controller 3 transmits the list of battery chargers to the user terminal 6 (steps S814 and S815) and causes the battery charger 4 determined by the user terminal 6 to start recharging (step S916). When the communication between the server 1 and the recharging controller 3 recovers to online after the end of recharging, the recharging controller 3 transmits log data that has occurred during offline to the server 1, and the server 1 can perform a billing process (step S940). Note that, in the present example embodiment, the server 1 is not required to perform searching for the recharging controller 3 (steps S719 to S723). Further, the user terminal 6 may display receivable SSIDs as a list of the recharging controllers 3 (steps S802 and S804).

According to the present example embodiment, when the recharging controller 3 is unable to communicate with the server 1, the recharging controller 3 can authenticate the user terminal 6 and determine start of recharging. Further, after the communication between the recharging controller 3 and the server 1 recovers, a billing process by the server 1 can be performed.

### Fourth Example Embodiment

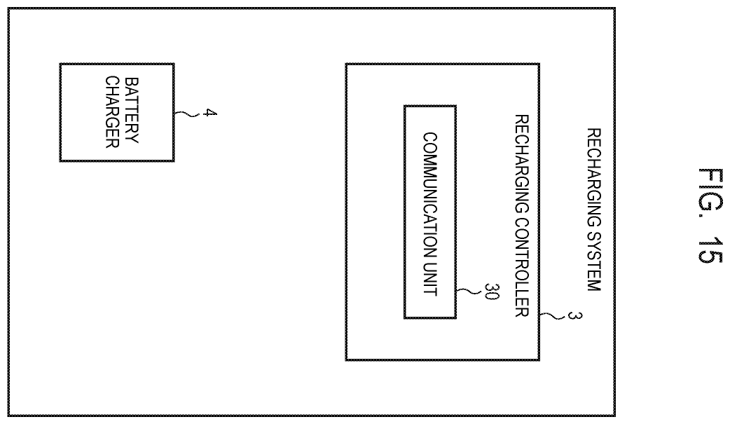

FIG. 15 is a general configuration diagram of the recharging system according to each example embodiment described above. The recharging system has a recharging controller 3 and a battery charger 4 that can charge a battery of a vehicle. The recharging controller 3 can control the battery charger 4 and communication with a server. The recharging controller 3 has a communication unit 30 capable of wirelessly communicating with a user terminal. The server acquires position information on the user terminal from the communication unit 30 and transmits an instruction of start of recharging from the user terminal to the recharging controller 3 corresponding to the position information. According to such a configuration, at the user terminal, the user is able to instruct the recharging controller to start recharging and is not required to move to the recharging controller installed in a distant place. Therefore, according to the present example embodiment, a recharging system that enhances user-friendliness can be provided.

### Other Example Embodiments

The present invention is not limited to the example embodiments described above and can be changed as appropriate within a scope not departing from the spirit of the present invention. For example, the plurality of recharging controllers 3 may be connected to each other, or the user terminal 6 may communicate with one recharging controller 3 via another recharging controller 3. Further, respective functions assigned to the server 1, the recharging controller 3, the battery charger 4, and the user terminal 6 are not necessarily limited to those in the example embodiments described above as long as the recharging system can implement the functions described above as a whole. In the first example embodiment, a part or whole of the function of one of the charging ECUs 501 may be performed in the other. Furthermore, in the second example embodiment, a part or whole of the function of one of the charging ECU 501 and the user terminal 6 may be performed in the other. The user terminal 6 may not necessarily be required to be carried by the user but may be fixed to the vehicle 5.

Further, position information may be acquired by other schemes without being limited to those based on the SSID or the GPS. For example, a gyro sensor may be provided in the user terminal 6, and the position of the user terminal 6 may be acquired based on a reception electric wave intensity at the user terminal 6. Further, an arrival time difference of signals from the plurality of recharging controllers 3 may be detected by using ultra-wide band wireless communication to acquire the position of the user terminal 6. Furthermore, when the user terminal is unable to acquire the position information from an SSID, a GPS, or the like, the user may manually input an address, a shop name, or an identification number of the recharging controller 3 to the user terminal 6.

While a recharging system using the charging cable 4a has been described as an example in the first to third example embodiments, the present invention is also applicable to a contactless charging system using no charging cable. Further, in the first and second example embodiments, while the server 1 performs authentication of the user ID, billing process, or the like, the recharging controller 3 may perform authentication of the user ID, billing process, or the like. That is, a part or whole of the function of the server 1 may be performed in the recharging controller 3. Furthermore, in the first and second example embodiments, a part or whole of the function of the recharging controller 3 may be performed in the server 1.

The application program responsible for the operation of the server 1, the recharging controller 3, the battery charger 4, or the user terminal 6 may be created in any format as long as it is in a form executable by a computer. The application program may be provided by a storage medium such as an optical disk, a magnetic disk, a flash memory, a hard disk, or the like or may be provided through a telecommunication line such as the Internet.

The whole or part of the example embodiments disclosed above can be described as, but not limited to, the following supplementary notes.

(Supplementary Note 1)

A recharging system comprising:

battery chargers each capable of charging a battery of a vehicle; and

recharging controllers each configured to control the battery chargers and capable of communicating with a server,

wherein each of the recharging controllers includes a communication unit capable of wirelessly communicating with a user terminal, and

wherein the server acquires position information on the user terminal from the communication unit and transmits, to the recharging controllers corresponding to the position information, an instruction from the user terminal to start recharging.

(Supplementary Note 2)

The recharging system according to supplementary note 1, wherein the communication unit is provided to the recharging controller, and wherein the server acquires the position information on the user terminal based on an identifier of the communication unit.

(Supplementary Note 3)

The recharging system according to supplementary note 1, wherein the server acquires the position information based on positioning performed by the user terminal using a Global Positioning System (GPS).

(Supplementary Note 4)

The recharging system according to any one of supplementary notes 1 to 3, wherein the server transmits a list of the recharging controllers corresponding to the position information to the user terminal, and the user terminal establishes wireless communication with one of the recharging controllers determined by the user terminal on the list of the recharging controllers.

(Supplementary Note 5)

The recharging system according to supplementary note 4, wherein the determined recharging controller transmits, to the user terminal, a list of the battery chargers which are enabled to start recharging, and causes the battery charger determined by the user terminal on the list of the battery chargers to start recharging.

(Supplementary Note 6)

The recharging system according to supplementary note 5, wherein, when authentication of the user terminal is successful, the server allows recharging at the determined battery charger.

(Supplementary Note 7)

The recharging system according to any one of supplementary notes 1 to 6, wherein the user terminal is able to be carried by a user.

(Supplementary Note 8)

The recharging system according to any one of supplementary notes 1 to 6, wherein the user terminal is provided with the vehicle.

(Supplementary Note 9)

The recharging system according to supplementary note 1, wherein, when communication between the recharging controllers and the server is offline, each of the recharging controllers performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controllers and the server becomes online after end of the recharging, transmits log data occurring during an offline state to the server.

(Supplementary Note 10)

A recharging controller that controls battery chargers each capable of charging a battery of a vehicle and is capable of communicating with a server, the recharging controller comprising a communication unit capable of wirelessly communicating with a user terminal,

wherein the server acquires position information on the user terminal and transmits, to the recharging controller corresponding to the position information, an instruction from the user terminal to start recharging.

(Supplementary Note 11)

The recharging controller according to supplementary note 10, wherein the communication unit is provided to the recharging controller, and wherein the server acquires the position information on the user terminal based on an identifier of the communication unit.

(Supplementary Note 12)

The recharging controller according to supplementary note 10, wherein the server acquires the position information based on positioning performed by the user terminal using a Global Positioning System (GPS).

(Supplementary Note 13)

The recharging controller according to any one of supplementary notes 10 to 12, wherein the server transmits a list of the recharging controllers corresponding to the position information to the user terminal, and the user terminal establishes wireless communication with the recharging controller determined by the user terminal on the list of the recharging controllers.

(Supplementary Note 14)

The recharging controller according to supplementary note 13, wherein the determined recharging controller transmits, to the user terminal, a list of the battery chargers which are enabled to start recharging, and causes the battery charger determined by the user terminal on the list of the battery chargers to start recharging.

(Supplementary Note 15)

The recharging controller according to supplementary note 14, wherein, when authentication of the user terminal is successful, the server allows recharging at the determined battery charger.

(Supplementary Note 16)

The recharging controller according to any one of supplementary notes 10 to 15, wherein the user terminal is able to be carried by a user.

(Supplementary Note 17)

The recharging controller according to any one of supplementary notes 10 to 15, wherein the user terminal is provided with the vehicle.

(Supplementary Note 18)

The recharging controller according to supplementary note 10, wherein, when communication between the recharging controller and the server is offline, the recharging controller performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controller and the server becomes online after end of the recharging, transmits log data occurring during an offline state to the server.

(Supplementary Note 19)

A battery charger that is controlled by a recharging controller capable of communicating with a server and is capable of charging a battery of a vehicle,

wherein the recharging controller includes a communication unit capable of wirelessly communicating with a user terminal, and

wherein the server acquires position information on the user terminal from the recharging controller and transmits, to the recharging controller corresponding to the position information, an instruction from the user terminal to start recharging.

(Supplementary Note 20)

The battery charger according to supplementary note 19, wherein the communication unit is provided to the recharging controller, and wherein the server acquires the position information on the user terminal based on an identifier of the communication unit.

(Supplementary Note 21)

The battery charger according to supplementary note 19, wherein the server acquires the position information based on positioning performed by the user terminal using a Global Positioning System (GPS).

(Supplementary Note 22)

The battery charger according to any one of supplementary notes 19 to 21, wherein the server transmits a list of the recharging controllers corresponding to the position information to the user terminal, and the user terminal establishes wireless communication with the recharging controller determined by the user terminal on the list of the recharging controllers.

(Supplementary Note 23)

The battery charger according to supplementary note 22, wherein the server transmits a list of the recharging controllers corresponding to the position information to the user terminal, and the user terminal establishes wireless communication with the recharging controller determined by the user terminal on the list of the recharging controllers.

(Supplementary Note 24)

The battery charger according to supplementary note 23, wherein the determined recharging controller transmits, to the user terminal, a list of the battery chargers which are enabled to start recharging, and causes the battery charger determined by the user terminal on the list of the battery chargers to start recharging.

(Supplementary Note 25)

The battery charger according to supplementary note 24, wherein, when authentication of the user terminal is successful, the server allows recharging at the determined battery charger.

(Supplementary Note 26)

The battery charger according to any one of supplementary notes 19 to 25, wherein the user terminal is able to be carried by a user.

(Supplementary Note 27)

The battery charger according to any one of supplementary notes 19 to 25, wherein the user terminal is provided with the vehicle.

(Supplementary Note 28)

The battery charger according to supplementary note 19, wherein, when communication between the recharging controller and the server is offline, the recharging controller performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controller and the server becomes online after end of the recharging, transmits log data occurring during an offline state to the server.

(Supplementary Note 29)

A user terminal that is capable of wirelessly communicating with a recharging controller that controls battery chargers each capable of charging a battery of a vehicle and is controlled by a server,

wherein the recharging controller includes a communication unit capable of wirelessly communicating with a user terminal, and

wherein the server acquires position information on the user terminal from the communication unit and transmits, to the recharging controller corresponding to the position information, an instruction from the user terminal to start recharging.

(Supplementary Note 30)

The user terminal according to supplementary note 29, wherein the communication unit is provided to the recharging controller, and wherein the server acquires the position information on the user terminal based on an identifier of the communication unit.

(Supplementary Note 31)

The user terminal according to supplementary note 29, wherein the server acquires the position information based on positioning performed by the user terminal using a Global Positioning System (GPS).

(Supplementary Note 32)

The user terminal according to any one of supplementary notes 29 to 31, wherein the server transmits a list of the recharging controllers corresponding to the position information to the user terminal, and the user terminal establishes wireless communication with the recharging controller determined by the user terminal on the list of the recharging controllers.

(Supplementary Note 33)

The user terminal according to supplementary note 32, wherein the determined recharging controller transmits, to the user terminal, a list of the battery chargers which are enabled to start recharging, and causes the battery charger determined by the user terminal on the list of the battery chargers to start recharging.

(Supplementary Note 34)

The user terminal according to supplementary note 33, wherein, when authentication of the user terminal is successful, the server allows recharging at the determined battery charger.

(Supplementary Note 35)

The user terminal according to any one of supplementary notes 29 to 34, wherein the user terminal is able to be carried by a user.

(Supplementary Note 36)

The user terminal according to any one of supplementary notes 29 to 34, wherein the user terminal is provided with the vehicle.

(Supplementary Note 37)

The user terminal according to supplementary note 29, wherein, when communication between the recharging controller and the server is offline, the recharging controller performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controller and the server becomes online after end of the recharging, transmits log data occurring during an offline state to the server.

(Supplementary Note 38)

A recharging method performed by a recharging system including battery chargers each capable of charging a battery of a vehicle and recharging controllers each configured to control the battery chargers and comprising a communication unit capable of communicating with a server, the recharging method comprising steps of:

acquiring position information on a user terminal from a communication unit of each of the recharging controllers; and

transmitting, from the server to the recharging controllers corresponding to the position information, an instruction from the user terminal to start recharging.

(Supplementary Note 39)

The recharging method according to supplementary note 38, wherein the server acquires the position information on the user terminal based on an identifier of the communication unit.

(Supplementary Note 40)

The recharging method according to supplementary note 38, wherein the server acquires the position information based on positioning performed by the user terminal using a Global Positioning System (GPS).

(Supplementary Note 41)

The recharging method according to any one of supplementary notes 38 to 40, wherein the server transmits a list of the recharging controllers corresponding to the position information to the user terminal, and the user terminal establishes wireless communication with one of the recharging controllers determined by the user terminal on the list of the recharging controllers.

(Supplementary Note 42)

The recharging method according to supplementary note 41, wherein the determined recharging controller transmits, to the user terminal, a list of the battery chargers which are enabled to start recharging, and causes the battery charger determined by the user terminal on the list of the battery chargers to start recharging.

(Supplementary Note 43)

The recharging method according to supplementary note 42, wherein, when authentication of the user terminal is successful, the server allows recharging at the determined battery charger.

(Supplementary Note 44)

The recharging method according to any one of supplementary notes 38 to 43, wherein the user terminal is able to be carried by a user.

(Supplementary Note 45)

The recharging method according to any one of supplementary notes 38 to 43, wherein the user terminal is provided with the vehicle.

(Supplementary Note 46)

The recharging method according to supplementary note 38, wherein, when communication between the recharging controllers and the server is offline, each of the recharging controllers performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controllers and the server becomes online after end of the recharging, transmits log data occurring during an offline state to the server.

(Supplementary Note 47)

A recharging method that is performed by a recharging controller that controls battery chargers each capable of charging a battery of a vehicle and is capable of communicating with a server, the recharging method comprising steps of:

at a wireless communication unit, wirelessly communicating with a user terminal, and at the recharging controller corresponding to position information on the user terminal acquired by the server, receiving, from the server, an instruction from the user terminal to start recharging.

(Supplementary Note 48)

The recharging method according to supplementary note 47, wherein the server acquires the position information on the user terminal based on an identifier of the communication unit.

(Supplementary Note 49)

The recharging method according to supplementary note 47, wherein the server acquires the position information based on positioning performed by the user terminal using a Global Positioning System (GPS).

(Supplementary Note 50)

The recharging method according to any one of supplementary notes 47 to 49, wherein the server transmits a list of the recharging controllers corresponding to the position information to the user terminal, and the user terminal establishes wireless communication with one of the recharging controllers determined by the user terminal on the list of the recharging controllers.

(Supplementary Note 51)

The recharging method according to supplementary note 50, wherein the determined recharging controller transmits, to the user terminal, a list of the battery chargers which are enabled to start recharging, and causes the battery charger determined by the user terminal on the list of the battery chargers to start recharging.

(Supplementary Note 52)

The recharging method according to supplementary note 51, wherein, when authentication of the user terminal is successful, the server allows recharging at the determined battery charger.

(Supplementary Note 53)

The recharging method according to any one of supplementary notes 47 to 52, wherein the user terminal is able to be carried by a user.

(Supplementary Note 54)

The recharging method according to any one of supplementary notes 47 to 52, wherein the user terminal is provided with the vehicle.

(Supplementary Note 55)

The recharging method according to supplementary note 47, wherein, when communication between the recharging controllers and the server is offline, each of the recharging controllers performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controllers and the server becomes online after end of the recharging, transmits log data occurring during an offline state to the server.

(Supplementary Note 56)

A recharging method that is performed by a battery charger that is controlled by a recharging controller capable of communicating with a server and is capable of charging a battery of a vehicle, the recharging method comprising a step of:

by the recharging controller wirelessly communicating with a user terminal by using a communication unit, and by the server transmitting, to the recharging controllers corresponding to the position information on the user terminal, an instruction from the user terminal to start recharging, the battery charger receiving the instruction to start recharging from the recharging controller.

(Supplementary Note 57)

The recharging method according to supplementary note 56, wherein the server acquires the position information on the user terminal based on an identifier of the communication unit.

(Supplementary Note 58)

The recharging method according to supplementary note 56, wherein the server acquires the position information based on positioning performed by the user terminal using a Global Positioning System (GPS).

(Supplementary Note 59)

The recharging method according to any one of supplementary notes 56 to 58, wherein the server transmits a list of the recharging controllers corresponding to the position information to the user terminal, and the user terminal establishes wireless communication with one of the recharging controllers determined by the user terminal on the list of the recharging controllers.

(Supplementary Note 60)

The recharging method according to supplementary note 59, wherein the determined recharging controller transmits, to the user terminal, a list of the battery chargers which are enabled to start recharging, and causes the battery charger determined by the user terminal on the list of the battery chargers to start recharging.

(Supplementary Note 61)

The recharging method according to supplementary note 60, wherein, when authentication of the user terminal is successful, the server allows recharging at the determined battery charger.

(Supplementary Note 62)

The recharging method according to any one of supplementary notes 56 to 61, wherein the user terminal is able to be carried by a user.

(Supplementary Note 63)

The recharging method according to any one of supplementary notes 56 to 61, wherein the user terminal is provided with the vehicle.

(Supplementary Note 64)

The recharging method according to supplementary note 56, wherein, when communication between the recharging controllers and the server is offline, each of the recharging controllers performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controllers and the server becomes online after end of the recharging, transmits log data occurring during an offline state to the server.

(Supplementary Note 65)

A recharging method that is performed by a user terminal capable of wirelessly communicating with a recharging controller that controls battery chargers each capable of charging a battery of a vehicle and is controlled by a server, the recharging method comprising a step of:

the user terminal wirelessly communicating with a communication unit of the recharging controller, wherein the server acquires position information on the user terminal from the communication unit and transmits, to the recharging controller corresponding to the position information, an instruction from the user terminal to start recharging.

(Supplementary Note 66)

The recharging method according to supplementary note 65, wherein the server acquires the position information on the user terminal based on an identifier of the communication unit.

(Supplementary Note 67)

The recharging method according to supplementary note 65, wherein the server acquires the position information based on positioning performed by the user terminal using a Global Positioning System (GPS).

(Supplementary Note 68)

The recharging method according to any one of supplementary notes 65 to 67, wherein the server transmits a list of the recharging controllers corresponding to the position information to the user terminal, and the user terminal establishes wireless communication with one of the recharging controllers determined by the user terminal on the list of the recharging controllers.

(Supplementary Note 69)

The recharging method according to supplementary note 68, wherein the determined recharging controller transmits, to the user terminal, a list of the battery chargers which are enabled to start recharging, and causes the battery charger determined by the user terminal on the list of the battery chargers to start recharging.

(Supplementary Note 70)

The recharging method according to supplementary note 69, wherein, when authentication of the user terminal is successful, the server allows recharging at the determined battery charger.

(Supplementary Note 71)

The recharging method according to any one of supplementary notes 65 to 70, wherein the user terminal is able to be carried by a user.

(Supplementary Note 72)

The recharging method according to any one of supplementary notes 65 to 70, wherein the user terminal is provided with the vehicle.

(Supplementary Note 73)

The recharging method according to supplementary note 65, wherein, when communication between the recharging controllers and the server is offline, each of the recharging controllers performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controllers and the server becomes online after end of the recharging, transmits log data occurring during an offline state to the server.

(Supplementary Note 74)

A storage medium storing a program that causes a computer to execute a recharging method performed by a recharging system including battery chargers each capable of charging a battery of a vehicle and recharging controllers each configured to control the battery chargers and comprising a communication unit capable of communicating with a server, the recharging method comprising steps of:

acquiring position information on a user terminal from a communication unit of each of the recharging controllers; and

transmitting, from the server to the recharging controllers corresponding to the position information, an instruction from the user terminal to start recharging.

(Supplementary Note 75)

The storage medium according to supplementary note 74, wherein the server acquires the position information on the user terminal based on an identifier of the communication unit.

(Supplementary Note 76)

The storage medium according to supplementary note 74, wherein the server acquires the position information based on positioning performed by the user terminal using a Global Positioning System (GPS).

(Supplementary Note 77)

The storage medium according to any one of supplementary notes 74 to 76, wherein the server transmits a list of the recharging controllers corresponding to the position information to the user terminal, and the user terminal establishes wireless communication with one of the recharging controllers determined by the user terminal on the list of the recharging controllers.

(Supplementary Note 78)

The storage medium according to supplementary note 77, wherein the determined recharging controller transmits, to the user terminal, a list of the battery chargers which are enabled to start recharging, and causes the battery charger determined by the user terminal on the list of the battery chargers to start recharging.

(Supplementary Note 79)

The storage medium according to supplementary note 78, wherein, when authentication of the user terminal is successful, the server allows recharging at the determined battery charger.

(Supplementary Note 80)

The storage medium according to any one of supplementary notes 74 to 79, wherein the user terminal is able to be carried by a user.

(Supplementary Note 81)

The storage medium according to any one of supplementary notes 74 to 79, wherein the user terminal is provided with the vehicle.

(Supplementary Note 82)

The storage medium according to supplementary note 74, wherein, when communication between the recharging controllers and the server is offline, each of the recharging controllers performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controllers and the server becomes online after end of the recharging, transmits log data occurring during an offline state to the server.

(Supplementary Note 83)

A storage medium storing a program that causes a computer to execute a recharging method performed by a recharging controller that controls battery chargers each capable of charging a battery of a vehicle and is capable of communicating with a server, the recharging method comprising steps of:

at a wireless communication unit, wirelessly communicating with a user terminal, and at the recharging controller corresponding to position information on the user terminal acquired by the server, receiving, from the server, an instruction from the user terminal to start recharging.

(Supplementary Note 84)

The storage medium according to supplementary note 83, wherein the server acquires the position information on the user terminal based on an identifier of the communication unit.

(Supplementary Note 85)

The storage medium according to supplementary note 83, wherein the server acquires the position information based on positioning performed by the user terminal using a Global Positioning System (GPS).

(Supplementary Note 86)

The storage medium according to any one of supplementary notes 83 to 85, wherein the server transmits a list of the recharging controllers corresponding to the position information to the user terminal, and the user terminal establishes wireless communication with one of the recharging controllers determined by the user terminal on the list of the recharging controllers.

(Supplementary Note 87)

The storage medium according to supplementary note 86, wherein the determined recharging controller transmits, to the user terminal, a list of the battery chargers which are enabled to start recharging, and causes the battery charger determined by the user terminal on the list of the battery chargers to start recharging.

(Supplementary Note 88)

The storage medium according to supplementary note 87, wherein, when authentication of the user terminal is successful, the server allows recharging at the determined battery charger.

(Supplementary Note 89)

The storage medium according to any one of supplementary notes 83 to 88, wherein the user terminal is able to be carried by a user.

(Supplementary Note 90)

The storage medium according to any one of supplementary notes 83 to 88, wherein the user terminal is provided with the vehicle.

(Supplementary Note 91)

The storage medium according to supplementary note 83, wherein, when communication between the recharging controllers and the server is offline, each of the recharging controllers performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controllers and the server becomes online after end of the recharging, transmits log data occurring during an offline state to the server.

(Supplementary Note 92)

A storage medium storing a program that causes a computer to execute a recharging method performed by a battery charger that is controlled by a recharging controller capable of communicating with a server and is capable of charging a battery of a vehicle, the recharging method comprising a step of:

by the recharging controller wirelessly communicating with a user terminal by using a communication unit, and by the server transmitting, to the recharging controllers corresponding to the position information on the user terminal, an instruction from the user terminal to start recharging, the battery charger receiving the instruction to start recharging from the recharging controller.

(Supplementary Note 93)

The storage medium according to supplementary note 92, wherein the server acquires the position information on the user terminal based on an identifier of the communication unit.

(Supplementary Note 94)

The storage medium according to supplementary note 92, wherein the server acquires the position information based on positioning performed by the user terminal using a Global Positioning System (GPS).

(Supplementary Note 95)

The storage medium according to any one of supplementary notes 92 to 94, wherein the server transmits a list of the recharging controllers corresponding to the position information to the user terminal, and the user terminal establishes wireless communication with one of the recharging controllers determined by the user terminal on the list of the recharging controllers.

(Supplementary Note 96)

The storage medium according to supplementary note 95, wherein the determined recharging controller transmits, to the user terminal, a list of the battery chargers which are enabled to start recharging, and causes the battery charger determined by the user terminal on the list of the battery chargers to start recharging.

(Supplementary Note 97)

The storage medium according to supplementary note 96, wherein, when authentication of the user terminal is successful, the server allows recharging at the determined battery charger.

(Supplementary Note 98)

The storage medium according to any one of supplementary notes 92 to 97, wherein the user terminal is able to be carried by a user.

(Supplementary Note 99)

The storage medium according to any one of supplementary notes 92 to 97, wherein the user terminal is provided with the vehicle.

(Supplementary Note 100)

The storage medium according to supplementary note 92, wherein, when communication between the recharging controllers and the server is offline, each of the recharging controllers performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controllers and the server becomes online after end of the recharging, transmits log data occurring during an offline state to the server.

(Supplementary Note 101)

A storage medium storing a program that causes a computer to execute a recharging method performed by a user terminal capable of wirelessly communicating with a recharging controller that controls battery chargers each capable of charging a battery of a vehicle and is controlled by a server, the recharging method comprising a step of: the user terminal wirelessly communicating with a communication unit of the recharging controller,

wherein the server acquires position information on the user terminal from the communication unit and transmits, to the recharging controller corresponding to the position information, an instruction from the user terminal to start recharging.

(Supplementary Note 102)

The storage medium according to supplementary note 101, wherein the server acquires the position information on the user terminal based on an identifier of the communication unit.

(Supplementary Note 103)

The storage medium according to supplementary note 101, wherein the server acquires the position information based on positioning performed by the user terminal using a Global Positioning System (GPS).

(Supplementary Note 104)

The storage medium according to any one of supplementary notes 101 to 103, wherein the server transmits a list of the recharging controllers corresponding to the position information to the user terminal, and the user terminal establishes wireless communication with one of the recharging controllers determined by the user terminal on the list of the recharging controllers.

(Supplementary Note 105)

The storage medium according to supplementary note 104, wherein the determined recharging controller transmits, to the user terminal, a list of the battery chargers which are enabled to start recharging, and causes the battery charger determined by the user terminal on the list of the battery chargers to start recharging.

(Supplementary Note 106)

The storage medium according to supplementary note 105, wherein, when authentication of the user terminal is successful, the server allows recharging at the determined battery charger.

(Supplementary Note 107)

The storage medium according to any one of supplementary notes 101 to 106, wherein the user terminal is able to be carried by a user.

(Supplementary Note 108)

The storage medium according to any one of supplementary notes 101 to 106, wherein the user terminal is provided with the vehicle.

(Supplementary Note 109)

The storage medium according to supplementary note 101, wherein, when communication between the recharging controllers and the server is offline, each of the recharging controllers performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controllers and the server becomes online after end of the recharging, transmits log data occurring during an offline state to the server.

This application is based upon and claims the benefit of priority from Japanese Patent Application No. 2016-243086, filed on Dec. 15, 2016, the disclosure of which is incorporated herein in its entirety by reference.

What is claimed is:

1. A recharging system comprising:
a server; and
recharging controllers that each control battery chargers each capable of charging a battery of a vehicle and are capable of communicating with the server,
wherein the server acquires position information on a user terminal and transmits, to the recharging controllers corresponding to the position information, an instruction from the user terminal to start recharging.

2. The recharging system according to claim 1, wherein the server acquires the position information on the user terminal based on an identifier of a communication unit included in each of the recharging controllers.

3. The recharging system according to claim 1, wherein the server acquires the position information based on positioning performed by the user terminal using a Global Positioning System (GPS).

4. The recharging system according to claim 1, wherein the server transmits a list of the recharging controllers corresponding to the position information to the user terminal, and the user terminal establishes wireless communication with one of the recharging controllers determined by the user terminal on the list of the recharging controllers.

5. The recharging system according to claim 4, wherein the determined recharging controller transmits, to the user terminal, a list of the battery chargers which are enabled to start recharging, and causes the battery charger determined by the user terminal on the list of the battery chargers to start recharging.

6. The recharging system according to claim 5, wherein, when authentication of the user terminal is successful, the server allows recharging at the determined battery charger.

7. The recharging system according to claim 1, wherein the user terminal is able to be carried by a user.

8. The recharging system according to claim 1, wherein the user terminal is provided with the vehicle.

9. The recharging system according to claim 1, wherein, when communication between the recharging controllers and the server is offline, each of the recharging controllers performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controllers and the server becomes online, transmits log data occurring during the offline state.

10. A recharging controller that controls battery chargers each capable of charging a battery of a vehicle and is capable of communicating with a server,
wherein the recharging controller receives an instruction from a user terminal to start recharging, via the server acquiring position information on the user terminal.

11. The recharging controller according to claim 10, further comprising a communication unit capable of communicating with the user terminal,
wherein the server acquires the position information on the user terminal based on an identifier of the communication unit.

12. The recharging controller according to claim 10, wherein the server acquires the position information based on positioning performed by the user terminal using a Global Positioning System (GPS).

13. The recharging controller according to claim 10, wherein the server transmits a list of the recharging controllers corresponding to the position information to the user terminal, and the user terminal establishes wireless communication with the recharging controller determined by the user terminal on the list of the recharging controllers.

14. The recharging controller according to claim 13, wherein the determined recharging controller transmits, to the user terminal, a list of the battery chargers which are enabled to start recharging, and causes the battery charger determined by the user terminal on the list of the battery chargers to start recharging.

15-17. (canceled)

18. The recharging controller according to claim 10, wherein, when communication between the recharging controller and the server is offline, the recharging controller performs authentication of the user terminal, transmits, to the user terminal for which the authentication succeeded, a list of the battery chargers which are enabled to start recharging, causes one of the battery chargers determined by the user terminal on the list of the battery chargers to start recharging, and after the communication between the recharging controller and the server becomes online transmits log data occurring during the offline state.

19-27. (canceled)

28. A user terminal that is used in a recharging system including a server and recharging controllers that each control battery chargers each capable of charging a battery of a vehicle and are capable of communicating with the server,
wherein the user terminal transmits position information on the user terminal to the server, and
wherein the user terminal receives a list of the recharging corresponding to the position Information.

29. The user terminal according to claim 28, wherein the user terminal transmits the position information on the user terminal to the server based on an identifier of a communication unit included in the recharging controller.

30. The user terminal according to claim 28, wherein the user terminal transmits the position information to the server based on positioning performed by the user terminal using a Global Positioning System (GPS).

31. The user terminal according to claim 28, wherein the user terminal receives the list of the recharging controllers corresponding to the position information from the server, and the user terminal establishes wireless communication with the recharging controller determined by the user terminal on the list of the recharging controllers.

32. The user terminal according to claim 31,
wherein the user, terminal receives a list of the battery chargers which are enabled to start recharging from the determined recharging controller, and
wherein the user terminal transmits an instruction to start recharging to the server to cause the battery charger determined by the user terminal on the list of the battery chargers to start recharging.

33. (canceled)

34. The user terminal according to claim 28, wherein the user terminal is able to be carried by a user.

35. The user terminal according to claim 28, wherein the user terminal is provided with the vehicle.

36. (canceled)

37. A recharging method performed by a recharging system including a server and recharging controllers that each control battery chargers each capable of charging a battery of a vehicle and are capable of communicating with the server, the recharging method comprising steps of:
acquiring position information on a user terminal by the server; and
transmitting, from the server to the recharging controllers corresponding to the position information, an instruction from the user terminal to start recharging.

38. A non-transitory storage medium storing a program that causes a computer to execute a recharging method performed by a recharging system comprising a server and recharging controllers that each control battery chargers each capable of charging a battery of a vehicle and are capable of communicating with the server, the recharging method comprising steps of:
acquiring position information on a user terminal by the server; and
transmitting a list of the recharging controllers corresponding to the position information from the server to the user terminal.

39. A non-transitory storage medium storing a program that causes a computer to execute a recharging method performed by a recharging controller that controls battery chargers each capable of charging a battery of a vehicle and is capable of communicating with a server, the recharging method comprising steps of:
at a wireless communication unit, wirelessly communicating with a user terminal, and
at the recharging controller corresponding to position information on the user terminal acquired by the server, receiving, from the server, an instruction from the user terminal to start recharging.

40. (canceled)

41. A non-transitory storage medium storing a program that causes a computer to execute a recharging method performed by a user terminal which is used in a recharging system including a server and recharging controllers that each control battery chargers each capable of charging a battery of a vehicle and are capable of communicating with the server, the recharging method comprising a step of:
transmitting position information on the user terminal to the server; and
receiving a list of the recharging controllers corresponding to the position information from the server.
